(19) United States
(12) Patent Application Publication
(10) Pub. No.: US 2009/0278775 A1
(43) Pub. Date: Nov. 12, 2009

(54) DISPLAY APPARATUS AND CONTROL METHOD OF THE SAME

(75) Inventors: Tae-Hyeun HA, Suwon-si (KR); Han-Feng Chen, Suwon-si (KR); Jun-ho Sung, Seoul (KR); Hyung-rae Kim, Seoul (KR); Jae-sung Park, Seoul (KR)

Correspondence Address: SUGHRUE MION, PLLC, 2100 PENNSYLVANIA AVENUE, N.W., SUITE 800, WASHINGTON, DC, 20037, US

(73) Assignee: Samsung Elctronics Co., Ltd., Suwon-si (KR)

(21) Appl. No.: 12/365,388

(22) Filed: Feb. 4, 2009

(30) Foreign Application Priority Data
May 9, 2008 (KR) 10-2008-0043327

(51) Int. Cl. G09G 3/34

(52) U.S. Cl. 345/84

(57) ABSTRACT

A display apparatus includes: a display unit which displays an image; and a signal controller which generates a first sub-frame having a mean brightness by calculating the mean brightness of an original frame input from an outside, generates at least one second sub-frame for compensating the first sub-frame on the basis of the first sub-frame and the original frame, and outputs the first sub-frame and the second sub-frame to be displayed on the display unit in sequence.

### CROSS-REFERENCE TO RELATED APPLICATION

This application claims priority from Korean Patent Application No. 10-2008-0043327, filed on May 9, 2008 in the Korean Intellectual Property Office, the disclosure of which is incorporated herein by reference.

### BACKGROUND OF INVENTION

1. Field of Invention

Apparatuses and methods consistent with the present invention relate to a display apparatus and a control method of the same, and more particularly to a hold type display apparatus and a control method of the same.

2. Description of the Related Art

A display apparatus may be classified into a hold type where an image is continuously displayed during one frame and an impulsive type where an image is displayed only for a short time of scanning a video signal within one frame. As an example of the impulsive-type display apparatus, there is a cathode ray tube (CRT). On the other hand, a liquid crystal display (LCD) having a liquid crystal layer, and an organic light emitting display (OLED) having an organic light emitting diode are examples of the hold-type display apparatus.

Such a hold-type display apparatus induces an image blurring phenomenon or a motion blur that does not occur in the impulsive-type display apparatus. The image blurring phenomenon more frequently appears as a displayed image approximates to a motion picture. Further, the image blurring phenomenon becomes more prominent as the size of the display apparatus increases since it should be driven more quickly in proportion to the size thereof.

To prevent the image blurring phenomenon, the motion blur or the like residual image, there has been used a driving method of inserting a black screen between screens where images are displayed. Such a driving method reduces the image blurring phenomenon that occurs in the display apparatus, but the black screen decreases the brightness of an image and causes a flicker due to difference in the brightness between neighboring frames.

### SUMMARY OF THE INVENTION

Accordingly, it is an aspect of the present invention to provide a display apparatus and a control method of the same, in which a motion blur and a flicker are decreased.

Another aspect of the present invention is to provide a display apparatus and a control method thereof, in which brightness is enhanced.

The foregoing and/or other aspects of the present invention can be achieved by providing a display apparatus including: a display unit which displays an image; and a signal controller which generates a first sub-frame having a mean brightness by calculating the mean brightness of an original frame input from an outside, generates at least one second sub-frame for compensating the first sub-frame on the basis of the first sub-frame and the original frame, and outputs the first sub-frame and the second sub-frame to be displayed on the display unit in sequence.

The signal controller may segment the original frame into a plurality of image blocks and may calculate a mean brightness of each segmental image block, and the first sub-frame is formed on the basis of the image block.

The signal controller may reduce difference in brightness between neighboring video signals corresponding to boundaries of the image block.

The signal controller may reduces the difference in brightness by setting brightnesses corresponding to the boundaries of two of the plurality of image blocks as average brightnesses of the neighboring video signals.

The signal controller may remove a high frequency image at the boundaries of the image block.

If the second sub-frame may be one, the brightness of the second sub-frame may be obtained by subtracting the brightness of the first sub-frame from a double brightness of the original frame.

The signal controller may include a first operator to increase the brightness of the original frame twice, and a second operator to subtract the brightness of the first sub-frame from the brightness of the video signal output from the first operator.

The display unit may include one of a liquid crystal display (LCD) panel, or an organic light emitting display (OLED) panel.

The foregoing and/or other aspects of the present invention can be achieved by providing a method of controlling a display apparatus, including: generating a first sub-frame having a mean brightness by calculating the mean brightness of an original frame input from an outside; generating at least one second sub-frame for compensating the first sub-frame on the basis of the first sub-frame and the original frame; and displaying the first sub-frame and the second sub-frame in sequence.

The generating the first sub-frame may include: segmenting the original frame into a plurality of image blocks; and calculating a mean brightness of each segmental image block.

The generating the first sub-frame may include reducing difference in brightness between neighboring video signals corresponding to boundaries of the image block.

The reducing the difference in the brightness may include setting the brightness of the video signals corresponding to the boundaries of the image blocks into the mean brightness between the neighboring video signals.

The reducing the difference in the brightness may include removing a high frequency image at the boundaries of the image block.

The generating the second sub-frame may include subtracting the brightness of the first sub-frame from a double brightness of the original frame.

### BRIEF DESCRIPTION OF THE DRAWINGS

The above and/or other aspects of the present invention will become apparent and more readily appreciated from the following description of the exemplary embodiments, taken in conjunction with the accompanying drawings, in which:

FIG. 1 is a control block diagram of a display apparatus according to a first embodiment of the present invention;

FIG. 2 illustrates input/output frames of the display apparatus in FIG. 1;

FIG. 3 is a control block diagram of a signal controller in FIG. 1;

FIG. 4 is a control block diagram of a signal controller according to a second embodiment of the present invention;

FIGS. 5A and 5B are views for explaining a video signal processing method of the signal controller in FIG. 4;

FIG. 6 is a control block diagram of a signal controller according to a third embodiment of the present invention;

FIG. 7 is a view for explaining a video signal processing method of the signal controller in FIG. 6;

FIG. 8 shows waveforms diagram corresponding to the brightness of a video signal in FIG. 6; and

FIG. 9 is a control flowchart for explaining a control method of the display apparatus according to the third embodiment of the present invention.

### DETAILED DESCRIPTION OF EXEMPLARY EMBODIMENTS OF THE INVENTION

Below, embodiments of the present invention will be described in detail with reference to accompanying drawings so as to be easily realized by a person having ordinary knowledge in the art. The present invention may be embodied in various forms without being limited to the embodiments set forth herein. Descriptions of well-known parts are omitted for clarity, and like reference numerals refer to like elements throughout.

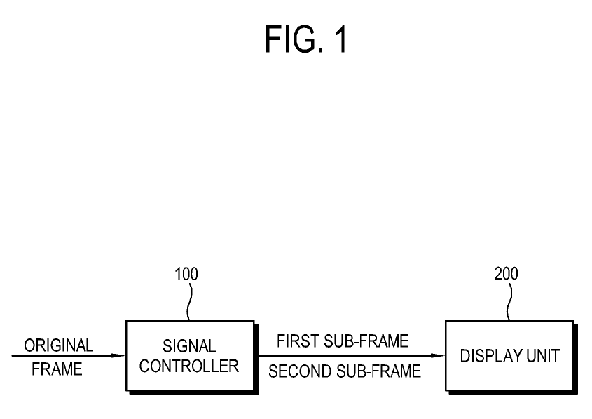

FIG. 1 is a control block diagram of a display apparatus according to a first embodiment of the present invention.

As shown therein, the display apparatus includes a signal controller 100 to process and control a video signal, and a display unit 200 to display an image.

The display unit 200 may include a liquid crystal display (LCD) panel including a liquid crystal layer, or an organic light emitting display (OLED) panel including an organic light emitting diode. The LCD panel or the OLED panel gives the display apparatus a hold-type characteristic.

The signal controller 100 generates a plurality of sub-frames based on an original frame input from the outside, and controls the plurality of sub-frames to be sequentially displayed on the display unit 200. Generally, the frame refers an image displayed on the display unit 200 during one unit time. In this embodiment, the frame refers to a displayed image or a video signal for the displayed image.

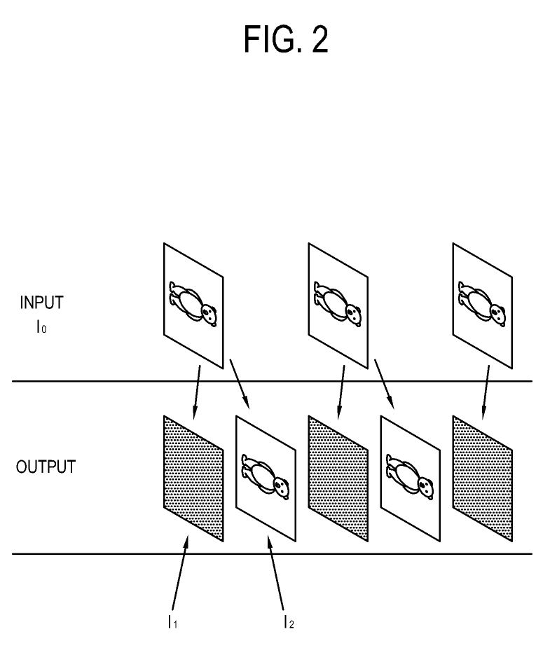

The signal controller 100 generates a first sub-frame and at least one second sub-frame from the original frame. FIG. 2 illustrates input/output frames of the display apparatus in FIG. 1. Referring to FIG. 2, the signal controller 100 according to the present embodiment generates one first sub-frame I₁ and one second sub-frame I₂ from the original frame I₀, and outputs the first sub-frame I₁ and the second sub-frame I₂ to the display unit 200 in sequence. In the case of a hold-type display apparatus, an increase in a frame frequency reduces an image blurring phenomenon and improves visibility. Through the signal controller 100, two sub-frames I₁ and I₂ are output with regard to one input original frame I₀, so that the frame frequency of an output image increases twice as high as the frame frequency of an input image. In addition, the signal controller 100 may generate three or more sub-frames so as to further increase the frame frequency.

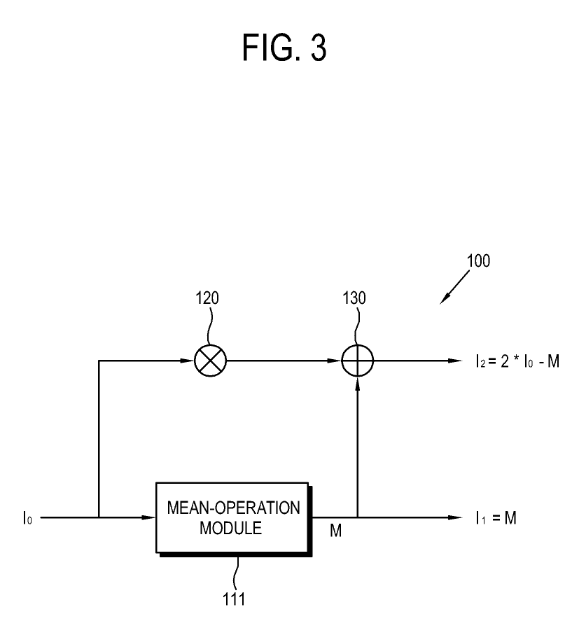

FIG. 3 is a control block diagram of the signal controller 100 in FIG. 1. As shown therein, the signal controller 100 includes a mean-operation module 111, a first operator 120, and a second operator 130. With this configuration, the signal controller 100 can generate the first sub-frame I₁ and the second sub-frame I₂ to be input to the display unit 200 (see FIG. 2).

The mean-operation module 111 calculates a mean brightness of the input original frame I₀ and thus generate the first sub-frame I₁. The mean-operation module 111 divides an input video signal according to colors, and calculates the mean brightness of each color, thereby generating the first sub-frame I₁ on the basis of the mean brightness. In more detail, the mean-operation module 111 calculates a mean brightness of a red signal, a mean brightness of a green signal, and a mean brightness of a blue signal, which compose the original frame I₀. If the video signals each having the mean brightness calculated according to colors are sequentially output during one frame, the first sub-frame I₁ is formed. The first sub-frame I₁ is input to and displayed on the display unit 200, and then input to the second operator 130 in order to generate the second sub-frame I₂.

The first sub-frame I₁ corresponds to a black screen that has been inserted so as to have an impulsive-type driving effect. Because the black screen is inserted between the image frames, the brightness of an image is noticeably decreased and a flicker occurs due to difference in the brightness between neighboring frames. However, in this embodiment, the first sub-frame I₁ having the mean brightness M of the original frame I₀ is inserted instead of the black screen having no brightness, so that the flicker can be reduced while having the impulsive-type driving effect as if the black screen is inserted.

Further, the original frame I₀ is input to the first operator 120 corresponding to a multiplier and the second operator 130 corresponding to a subtractor in sequence. The first operator 120 doubles the brightness of the original frame I₀ and then outputs it to the second operator 130. The second operator 130 subtracts the brightness (mean brightness M) of the first sub-frame I₁ output from the mean operation module 111 from the brightness output from the first operator 120. The second sub-frame I₂ is provided for compensating the brightness of the first sub-frame I₁, so that the mean brightness between the first sub-frame I₁ and the second sub-frame I₂ can be adjusted to approach the brightness of the original frame I₀.

As a result, the signal controller 100 generates the first sub-frame I₁ by operating the mean brightness of the original frame I₀, and generates the second sub-frame I₂ for compensating the first sub-frame I₁ on the basis of the first sub-frame I₁ and the original frame I₀, thereby outputting the first sub-frame I₁ and the second sub-frame I₂ to the display unit 200 in sequence. Referring to FIG. 3, the brightness of the first sub-frame I₁ corresponds to the mean brightness M, and the brightness of the second sub-frame I₂ corresponds to the brightness {2*I₀−M} obtained by subtracting the mean brightness of the first sub-frame I₁ from the double brightness of the original frame I₀.

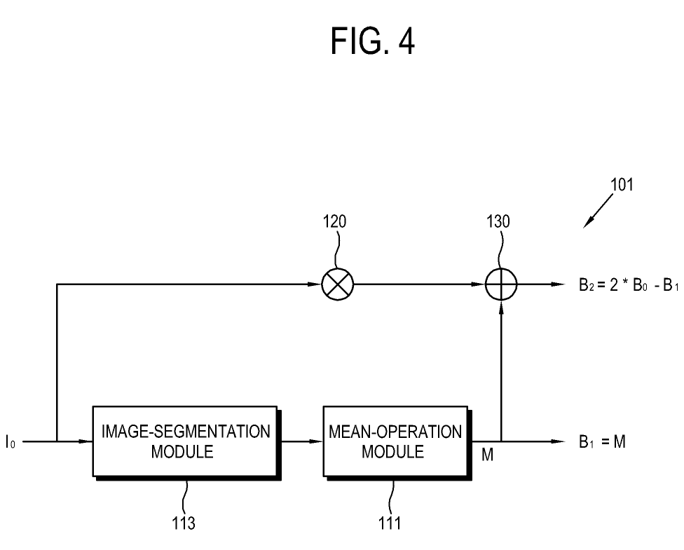

FIG. 4 is a control block diagram of a signal controller according to a second embodiment of the present invention. As shown therein, the signal controller 101 includes an image-segmentation module 113 in addition to the mean-operation module 111, the first operator 120 and the second operator 130.

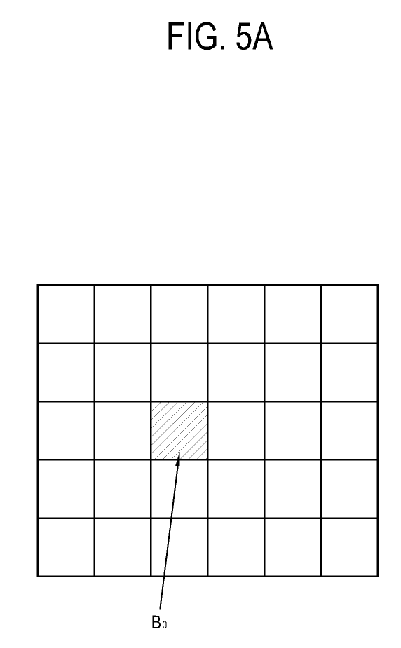

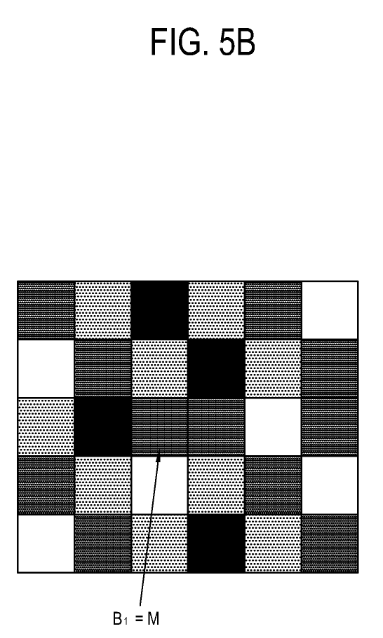

The image-segmentation module 113 segments the original frame I₀ into a plurality of image blocks, and the segmental image blocks are input to the mean-operation module 111 so that the mean brightness can be calculated. FIG. 5A illustrates that the original frame I₀ is segmented into the image blocks, including image block B₀, in the form of a matrix, and FIG. 5B shows the mean brightness of the segmental image block B₀. FIG. 5B shows the first sub-frame B₁ having the mean brightness M calculated according to the image block B₀. Therefore, each of the blocks of the plurality of image blocks shown in FIG. 5A, will have its own mean brightness M, as shown in FIG. 5B. As a result, an image block having a relatively high mean-brightness and an image block having a relatively low mean-brightness can be mixed in with each other. In this case, the mean brightness by more finely segmenting the original frame, so that the original brightness of the original frame I₀ can be better applied to the first sub-frame B₁. Further, since difference in the brightness between the first sub-frame B₁ and the second sub-frame B₂ decreases, the flicker can be also reduced. The first sub-frame B₁ constituted by the image blocks B₀ each having the mean brightness is input to the second operator 130, and undergoes the same operation as the first embodiment. Then, the first sub-frame B₁ output from the mean-operation module 111 and the second sub-frame B₂ output from the second operator 130 are input to the display unit 200 in sequence. The first sub-frame B₁ may output first or the second sub-frame B₂ may output first.

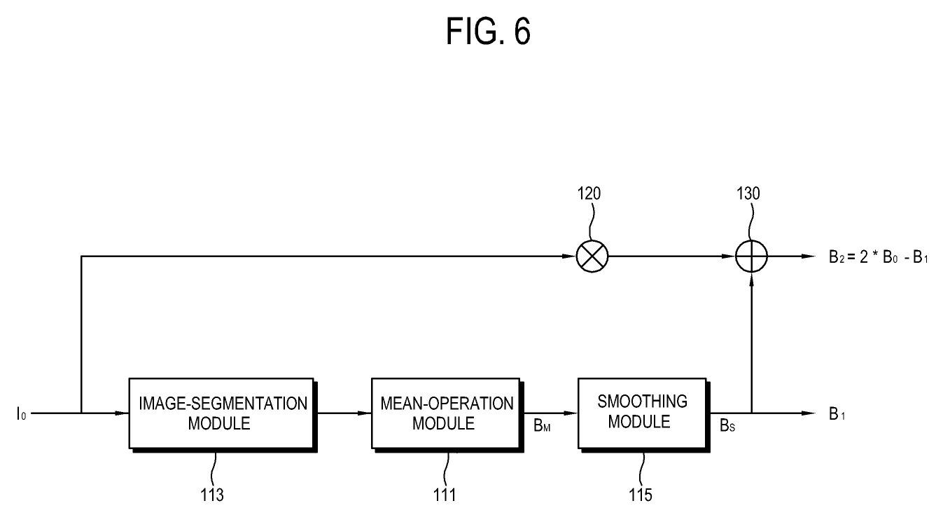

FIG. 6 is a control block diagram of a signal controller according to a third embodiment of the present invention. As shown therein, the signal controller 103 according to this embodiment further includes a smoothing module 115.

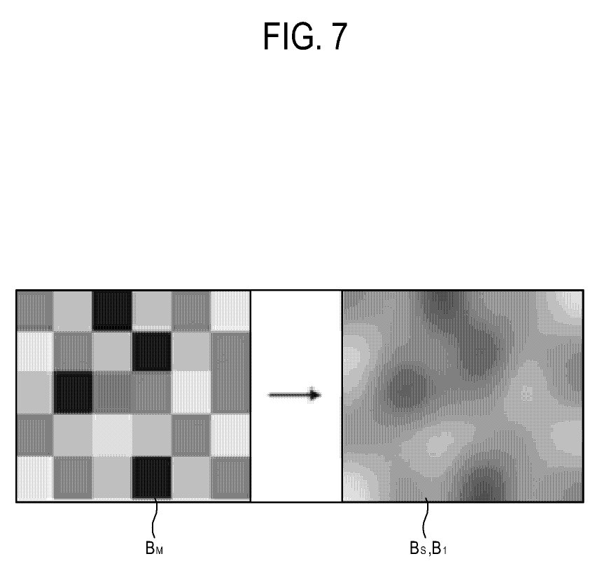

The smoothing module 115 decreases difference between video signals corresponding to boundaries of image blocks. That is, the difference in the brightness between the image blocks according to the second embodiment is gently reduced, thereby smoothing the boundaries between the image blocks. FIG. 7 shows the first sub-frame B_{S}, B₁ obtained as the smoothing module 115 smoothes the sub-frame B_{M} constituted by the image blocks each having the calculated mean brightness. Referring to FIG. 7, the sub-frame B_{M} having the distinctive boundaries is changed to have less distinct boundaries. Thus, as the smoothing operation is performed to reduce the difference in the brightness between the image blocks, the input video signal is prevented from a blocking phenomenon and a motion picture becomes more natural. According to the third embodiment, since the first sub-frame B₁ has the mean brightness corresponding to the segmental image blocks, the first sub-frame B₁ has less brightness difference from the original frame I₀ than the black screen and a residual image due to input of a motion picture is reduced by applying the smoothing operation between the image blocks.

The smoothing module 115 may change the brightness of the video signals corresponding to the boundaries of the image blocks into the mean brightness between the neighboring video signals. For example, suppose that the image block having a mean brightness of “10” is neighboring an the image block having a mean brightness of “100”. Here, the brightness of the video signal has a pattern of “10 10 10 100 100 100”. In this case, if the brightness has a pattern “10 10 10”, the mean brightness is “10.” Where the brightness has a pattern of “10 10 100”, the mean brightness is “40.” Where the brightness has a pattern of “10 100 100”, the mean brightness is “70.” Where the brightness has a pattern of “100 100 100”, the mean brightness is “100”. That is, the brightness between the boundaries of two image blocks is changed not suddenly from “10” to “100” but smoothly in the form of “10 10 40 70 100 100”. This is an example of reducing the brightness difference between the video signals corresponding to the boundaries of the image blocks.

Further, the smoothing module 115 may remove a high frequency image corresponding to the boundary of the image block. Here, the high-frequency image refers to a video signal of which brightness difference from neighboring video signal is very high. Further, converting the high frequency image into a video signal having a low brightness difference from neighboring video signal is represented as removing the high frequency image, and a module for implementing this process is called a low pass filter. In other words, the smoothing module 115 may smooth the boundaries of the image blocks by just calculating a mean value of the neighboring video signals, or remove the high frequency image. When the smoothing module 115 removes the high frequency image, it may be achieved by the low pass filter.

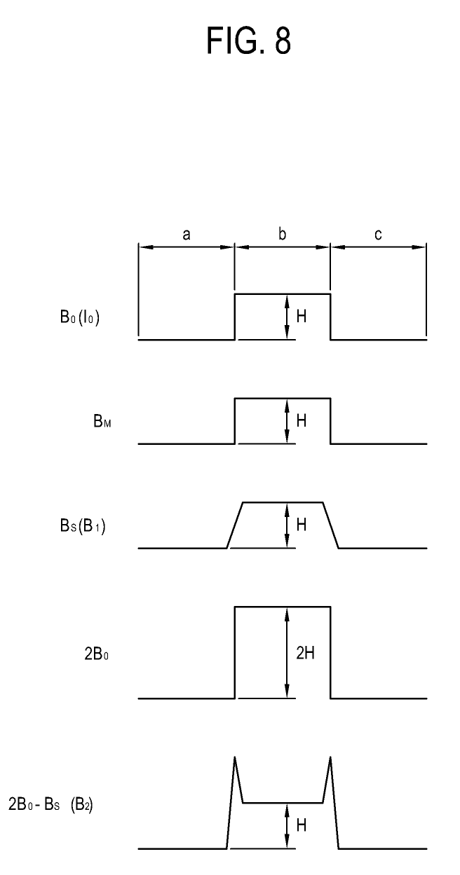

FIG. 8 shows waveforms corresponding to the brightness of the video signal in this embodiment. Here, “a”, “b”, and “c” indicates the segmental image blocks B₀. For convenience, suppose that the brightness of the input original frame I₀ is distinctively dividable according to the image blocks. If the image blocks a and c each have a brightness of 0 and the image block b has a brightness of H, the mean brightness M of each of the image blocks a, b, c is also equal to the brightness of the original image blocks a, b and c. In other words, the first waveform B₀ is the same as the second waveform B_{M}.

Then, the second waveform B_{M} undergoes the smoothing operation of the smoothing module 115, so that a smoothing sub-frame B_{S} is generated like the third waveform. In the smoothing sub-frame B_{S} corresponding to the first sub-frame B₁, a gradient between the image blocks is less steep than that of the sub-frame B_{M} having the mean brightness M.

The fourth waveform indicates the double brightness 2B₀ obtained by doubling the brightness of the image block B₀ of the original frame I0, and the fifth waveform indicates the second sub-frame B₂ obtained by subtracting the smoothing sub-frame B_{S} from the fourth waveform 2B₀. In the second sub-frame B₂, opposite boundaries of the image block b have peak waveforms in which brightness is higher than that of the input image block B₀. The peak waveforms have an effect on reducing the motion blur as if the video signal is applied in an impulsive-type driving manner. Further, the image block b has the brightness of H in both the first sub-frame B₁ and the second sub-frame B₂, so that the flicker due to the brightness difference can be reduced. According to the third embodiment, the signal controller 103 displays the smoothed sub-frame instead of the black screen in order to enhance the frame frequency, and uses the second sub-frame B₂ for compensating the brightness of the first sub-frame B₁ so as to have effect as if an image is displayed in the impulsive-type driving manner.

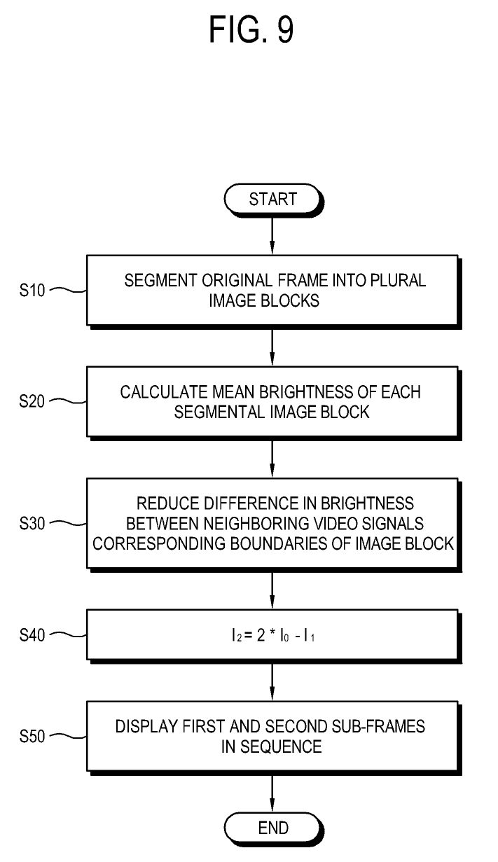

FIG. 9 is a control flowchart for explaining a control method of the display apparatus according to the third embodiment of the present invention. Referring to FIG. 9, the video signal processing method is as follows.

First, the image-segmentation module 113 segments the input original frame I₀ into a plurality of image blocks B₀ (S10).

The segmental image blocks B₀ is input to the mean-operation module 111, and the mean-operation module 111 calculates the mean brightness M of each image block B₀ (S20). The sub frame B_{M} constituted by the image blocks each having the mean brightness is decreased in the brightness difference between the boundaries of the image blocks through the smoothing module 115 (S30).

The first operator 120 increases the brightness of the original frame I₀ twice, and the second operator 130 subtracts the brightness of the first sub-frame I₁ that has the mean brightness and the smoothed boundaries from the double brightness of the original frame I₀ (S40).

The first sub-frame I₁ and the second sub-frame I₂ output from the second operator 130 are input to the display unit 200 in sequence (S50)

According to an embodiment of the present invention, the image blurring phenomenon and the residual image, which are caused when a motion picture is displayed in the hold-type display apparatus, are reduced. Further, to decrease the flicker, the first sub-frame I₁ having the mean brightness is generated, and the second sub-frame I₂ for compensating the brightness of the first sub-frame I₁ is generated.

As described above, the present invention to provide a display apparatus and a control method of the same, in which a motion blur and a flicker are decreased.

Another aspect of the present invention is to provide a display apparatus and a control method thereof, in which the brightness of an image is enhanced.

Still another aspect of the present invention is to provide a display apparatus and a control method thereof, in which a blocking phenomenon in an input motion picture is removed to thereby improve picture quality.

Although a few exemplary embodiments of the present invention have been shown and described, it will be appreciated by those skilled in the art that changes may be made in these embodiments without departing from the principles and spirit of the invention, the scope of which is defined in the appended claims and their equivalents.

What is claimed is:

1. A display apparatus comprising:
a display unit which displays an image; and
a signal controller which calculates a mean brightness of an original frame input from an outside, generates a first sub-frame having the mean brightness, generates at least one second sub-frame for compensating the first sub-frame based on the first sub-frame and the original frame, and outputs the first sub-frame and the second sub-frame,
wherein the display unit displays the first and the second sub-frames in sequence.

2. The display apparatus according to claim 1, wherein the signal controller segments the original frame into a plurality of image blocks and calculates mean brightnesses of the plurality of image blocks, and
the first sub-frame is formed based on mean brightnesses of the plurality of the image blocks.

3. The display apparatus according to claim 2, wherein the signal controller reduces a difference in brightness between neighboring video signals corresponding to boundaries of two of the plurality of image blocks.

4. The display apparatus according to claim 3, wherein the signal controller reduces the difference in brightness by setting brightnesses corresponding to the boundaries of two of the plurality of image blocks as average brightnesses of the neighboring video signals.

5. The display apparatus according to claim 3, wherein the signal controller removes a high frequency image at the boundaries of two of the plurality of image blocks.

6. The display apparatus according to claim 1, wherein, a brightness of the second sub-frame is obtained by subtracting the mean brightness of the first sub-frame from double a brightness of the original frame.

7. The display apparatus according to claim 6, wherein the signal controller comprises a first operator to double the brightness of the original frame, and a second operator to subtract the mean brightness of the first sub-frame from a brightness of the video signal output from the first operator.

8. The display apparatus according to claim 1, wherein the display unit comprises one of a liquid crystal display (LCD) panel, or an organic light emitting display (OLED) panel.

9. A method of controlling a display apparatus, comprising:
calculating a mean brightness of an original frame input from an outside;
generating a first sub-frame having the mean brightness;
generating at least one second sub-frame for compensating the first sub-frame based on the first sub-frame and the original frame; and
displaying the first sub-frame and the second sub-frame in sequence.

10. The method according to claim 9, wherein the generating the first sub-frame comprises:
segmenting the original frame into a plurality of image blocks; and
calculating mean brightnesses of the plurality of image blocks.

11. The method according to claim 10, wherein the generating the first sub-frame comprises reducing a difference in brightness between neighboring video signals corresponding to two of the plurality of image blocks.

12. The method according to claim 11, wherein the reducing the difference in the brightness comprises setting a mean brightness between the two of the plurality of image blocks as brightnesses of the two of the plurality of image blocks.

13. The method according to claim 11, wherein the reducing the difference in the brightness comprises removing a high frequency image at the boundaries of two of the plurality of image blocks.

14. The method according to claim 9, wherein the generating the second sub-frame comprises subtracting the mean brightness of the first sub-frame from double a brightness of the original frame.

15. A method of displaying motion picture in a hold-type display, the method comprising:
receiving an original image frame;
generating an intermediate image frame with an intermediate brightness between a peak brightness value in the original image frame and black;
generating a modified original image frame based on the intermediate image frame; and
displaying the intermediate image frame and the modified original frame in sequence in the hold-type display to reduce motion blur.
